(19) United States
(12) Patent Application Publication
(10) Pub. No.: US 2017/0054158 A1
(43) Pub. Date: Feb. 23, 2017

(54) METHOD FOR PREPARING METAL BIPOLAR PLATE OF FUEL CELL AND METAL BIPOLAR PLATE PREPARED BY THE SAME

(71) Applicant: KOREA INSTITUTE OF ENERGY RESEARCH, Daejeon (KR)

(72) Inventors: Rak-hyun SONG, Seoul (KR); Jung-won LEE, Daejeon (KR); Muhammad Shirjeel KHAN, Daejeon (KR); Jong-won LEE, Daejeon (KR); Tak-hyoung LIM, Daejeon (KR); Seok-joo PARK, Daejeon (KR); Seung-bok LEE, Daejeon (KR)

(21) Appl. No.: 15/238,779

(22) Filed: Aug. 17, 2016

(30) Foreign Application Priority Data
Aug. 17, 2015 (KR) 10-2015-0115560

(51) Int. Cl. H01M 8/0226; C25B 9/04; B22F 3/16; B22F 9/04; B22F 3/04; H01M 8/021; B22F 1/00

(52) U.S. Cl. CPC H01M 8/0226; H01M 8/021; C25B 9/04; B22F 1/0074; B22F 9/04; B22F 3/04; B22F 3/16; B22F 1/0062; H01M 2008/1293

(57) ABSTRACT

According to an embodiment of the present disclosure, a method for preparing a metal bipolar plate for a fuel cell includes drying, crushing, and mixing a Fe—Cr ferrite-based steel powder with a powder of an added element selected from the group consisting of LSM((La_{0.80}Sr_{0.20})_{0.95}MnO₃₋ₓ), La₂O₃, CeO₂, and LaCrO₃ to prepare a powder mixture, mixing and ball-milling the powder mixture with a solvent and binder into slurry, drying and press-forming the slurry into a pellet, cold isostatic pressing the pellet, and sintering the pellet.

### CROSS-REFERENCE TO RELATED APPLICATIONS

This patent application claims priority under 35 U.S.C. §119 to Korean Patent Application No. 10-2015-0115560, filed on Aug. 17, 2015, in the Korean intellectual Property Office, the disclosure of which is incorporated by reference herein in its entirety.

### TECHNICAL FIELD

The present disclosure concerns fuel cells, and specifically, to methods for preparing metal bipolar plates for fuel cells and metal bipolar plates prepared by the same.

### DISCUSSION OF RELATED ART

Metal bipolar plates in fuel cells, such as SOFC or SOEC, are positioned between ceramic cells each consisting of a fuel electrode, electrolyte, and air electrode to provide a separation between air and fuel. Long-term exposure to air may cause metal bipolar plates to lose conductivity. For proper use in fuel cells, metal bipolar plates are required to comply in thermal expansion coefficient with ceramic cells. Conventional metal bipolar plates for fuel cells are not capable enough to address such issues. Further, they suffer many other negative issues, such as high price, difficulty in processing, and performance deterioration. Therefore, a need exists for metal bipolar plates and methods for manufacturing the same which may address such issues.

### SUMMARY

According to an embodiment of the present disclosure, a method for preparing a metal bipolar plate for a fuel cell comprises drying, crushing, and mixing a Fe—Cr ferrite-based steel powder with a powder of an added element selected from the group consisting of LSM((La_{0.80}Sr_{0.20})_{0.95}MnO₃₋ₓ), La₂O₃, CeO₂, and LaCrO₃ to prepare a powder mixture, mixing and ball-milling the powder mixture with a solvent and binder into slurry, drying and press-forming the slurry into a pellet, cold isostatic pressing the pellet, and sintering the pellet.

The Fe—Cr ferrite-based steel powder may include iron (Fe) and chrome (Cr) as main components.

The Fe—Cr ferrite-based steel powder may include a Fe—Cr ferrite-based SUS430 powder.

The Fe—Cr ferrite-based steel powder and the added element powder may be mixed in a weight ratio of 90:10 to a weight ratio of 99.99:0.01.

The slurry may be prepared by mixing the powder mixture, the solvent, and the binder in a weight ratio of 1:1:0.01 to 0.03.

The solvent may include isopropyl alcohol or a mix of isopropyl alcohol and toluene in a weight ratio of 65:35.

The binder may include polyvinyl butyral.

The slurry may be dried at 90° C. to 100° C. in the air.

The pellet may be sintered at 1200° C. to 1400° C. in a hydrogen atmosphere for one hour to ten hours.

According to an embodiment of the present disclosure, a metal bipolar plate for a fuel cell is prepared by drying slurry including a Fe—Cr ferrite-based steel powder and a powder of an added element selected from the group consisting of LSM((La_{0.80}Sr_{0.20})_{0.95}MnO₃₋ₓ), La₂O₃, CeO₂, and LaCrO₃.

The slurry may be prepared by mixing a powder mixture of the Fe—Cr ferrite-based steel powder and the added element powder, a solvent, and a binder in a weight ratio of 1:1:0.01 to 0.03.

The Fe—Cr ferrite-based steel powder may include a Fe—Cr ferrite-based SUS430 powder.

The Fe—Cr ferrite-based steel powder and the added element powder may be mixed in a weight ratio of 90:10 to a weight ratio of 99.99:0.01.

According to an embodiment of the present disclosure, a fuel cell including a metal bipolar plate is prepared by drying slurry including a Fe—Cr ferrite-based steel powder and a powder of an added element selected from the group consisting of LSM((La_{0.80}Sr_{0.20})_{0.95}MnO₃₋ₓ), La₂O₃, CeO₂, and LaCrO₃.

The fuel cell may include a solid oxide fuel cell (SOFC) or solid oxide electrolysis cell (SOEC).

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a solid oxide fuel cell (SOFC) stack according to an embodiment of the present disclosure;

FIG. 2 illustrates SEM images of metal bipolar plate alloy materials respectively prepared according to comparison example 1 and the ninth to sixteenth embodiments of the present disclosure;

FIG. 3 illustrates EDS mapping images of a metal bipolar plate prepared according to comparison example 1;

FIG. 4 illustrates EDS mapping images of metal bipolar plate alloy materials respectively prepared according to the thirteenth to sixteenth embodiments of the present disclosure;

FIG. 5 illustrates EDS mapping images of metal bipolar plate alloy materials respectively prepared according to the ninth to twelfth embodiments of the present disclosure;

FIG. 6 is a graph illustrating a result of measurement of the thermal expansion coefficient of a metal bipolar plate prepared according to the twelfth embodiment of present disclosure, as obtained based on experimental example 4;

FIG. 7 is a view illustrating an example of measuring electrical resistance by a four-terminal method for measuring the area specific resistance of a metal bipolar plate, according to an embodiment of the present disclosure;

FIG. 8 is a graph illustrating a result of measurement of changes in area specific resistance of metal bipolar plates prepared according to the ninth to eleventh embodiments of the present disclosure, as obtained based on experimental example 6; and

FIG. 9 is a graph illustrating a result depending on heat cycle count of measurement of area specific resistance of a metal bipolar plate sample prepared according to the twelfth embodiment of the present disclosure, as obtained based on experimental example 7.

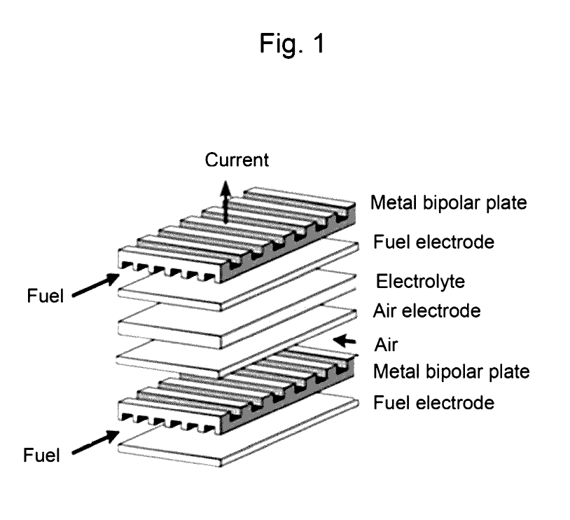

### DETAILED DESCRIPTION OF EXEMPLARY EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise. The terms or phrases used herein should not be interpreted in their typical or dictionary meanings, but rather may be construed to comply with technical matters of the present disclosure.

A method for manufacturing a metal bipolar plate for a fuel cell is described below according to an embodiment of the present disclosure.

A Fe—Cr ferrite-based steel powder and a powder of an added element selected from the group consisting of LSM((La_{0.80}Sr_{0.20})_{0.95}MnO₃₋ₓ), La₂O₃, CeO₂, and LaCrO₃ are dried, crushed, and mixed (step S1).

According to an embodiment of the present disclosure, in order to manufacture a metal bipolar plate for a fuel cell, a Fe—Cr ferrite-based steel powder complying in thermal expansion coefficient with a ceramic electrolyte is used, and the Fe—Cr ferrite-based steel powder is mixed with an added element selected from the group consisting of LSM((La_{0.80}Sr_{0.20})_{0.95}MnO₃₋ₓ), La₂O₃, CeO₂, and LaCrO₃.

The Fe—Cr ferrite-based steel has a BCC crystal structure and exhibits a much lower thermal expansion coefficient than that the austenite-based steel having an FCC crystal structure and generally used.

According to an embodiment of the present disclosure, the Fe—Cr ferrite-based steel may be prepared by mixing a Fe powder and a Cr powder in a weight ratio of 78 to 22 or by using a Fe—Cr ferrite-based SUS430 powder commercially available from, e.g., Metal Player Corp.

The Fe—Cr ferrite-based steel powder contains chrome (Cr). Cr may form Cr₂O₃ on the metal surface at a high-temperature oxidizing atmosphere, steadily grow to increase interface resistance, and causes a performance deterioration of the metal bipolar plate. Further, Cr₂O₃ already formed on the surface of the metal bipolar plate may be evaporated to deposit on the air electrode to cause Cr poisoning.

According to an embodiment of the present disclosure, use of a mixture of the Fe—Cr ferrite-based steel powder and a conductive ceramic material, such as an added element selected from the group consisting of LSM((La_{0.80}Sr_{0.20})_{0.95}MnO₃₋ₓ), La₂O₃, CeO₂, and LaCrO₃ may lead to a stable Cr coating to prevent a performance deterioration (refer to experimental examples 6 and 7 below).

According to an embodiment of the present disclosure, use of an added element selected from the group consisting of LSM((La_{0.80}Sr_{0.20})_{0.95}MnO₃₋ₓ), La₂O₃, CeO₂, and LaCrO₃, together with a Fe—Cr ferrite-based steel, may allow a highly oxidative rare-earth element contained in the added element powder to be left in the Cr oxide coating formed on the metal surface to increase the bonding between metal and oxide while giving the Cr oxide coating electronical conductivity, thereby reducing area specific resistance.

According to an embodiment of the present disclosure, unlike in the conventional art, the added element powder adds a rare-earth element in an oxide form but not in a metal form to an iron alloy. Adding a rare-earth element in a metal form but not in an oxide form may render it difficult to control thermal expansion coefficient, and since the rare-earth element may be easily oxidized in the air, high-cost vacuum fusion may be required as a process for adding rare-earth element to a melted iron alloy. According to an embodiment of the present disclosure, addition of a rare-earth element in an oxide form allows for easier control of thermal expansion coefficient and adoption of an in-air metal fusion process which is inexpensive.

According to an embodiment of the present disclosure, the Fe—Cr ferrite-based steel powder and the added element powder may be mixed in a weight ratio of 90:10 through a weight ratio of 99.99:0.01, and the mixture may be ball-milled, dried, crushed, and mixed.

Next, the powder mixture prepared in step S1 is mixed with a solvent and is ball-milled to prepare slurry (step S2).

For example, the powder mixture of Fe—Cr ferrite-based steel powder and added element powder prepared in step S1, a solvent, and a binder may be mixed together to prepare slurry.

As an example of the solvent, isopropyl alcohol or a solution obtained by mixing isopropyl alcohol and toluene in a weight ratio of 65:35 may be used. However, the solvent is not limited thereto, and any type of solvent may be used which may disperse the Fe—Cr ferrite-based steel powder and added element powder.

According to an embodiment of the present disclosure, as an example of the binder, a high-molecular binder, e.g., polyvinyl butyral, may be used, but not limited thereto. For example, any type of binder known to one of ordinary skilled in the art may be used as the binder.

In step S2, the powder mixture of Fe—Cr ferrite-based steel powder and added element powder, the solvent, and the binder may be mixed in a weight ratio of 1:1:0.01 to 0.03, for example.

Next, the slurry prepared in step S2 is dried into a powder, and the powder is press-formed into pellets (step S3).

For example, in step S3, the slurry prepared in step S2 may be dried at, e.g., 90° C. 100° C. in the air to obtain a powder, and the obtained powder may be uniaxial press-formed into, e.g., bar-shaped pellets.

Next, the pellets are cold isostatic press (CIP)-formed (step S4).

For example, the pellets that have undergone uniaxial press-forming are subjected to cold isostatic pressing (CIP) to have a higher density.

Lastly, the pellets are sintered (step S5).

For example, the pellets prepared in step S4 are loaded and sintered in a sintering furnace, e.g., in a reducing atmosphere to prevent formation of an oxide while sintering. Hydrogen supplied to form the reducing atmosphere may be rendered to pass through a dehumidifier to remove moisture therefrom and is then supplied to the sintering furnace.

Chrome (Cr) contained in the Fe—Cr ferrite-based steel may be difficult to sinter to have a high density due to evaporation of chrome oxide in the oxidizing atmosphere. Such evaporation occurs in a gaseous chrome compound, and while sintering, evaporation and condensation arise. Condensation typically occurs on a high-energy surface, such as particle surface and particle contact surface. Thus, the pellets may preferably be sintered under a low oxygen partial pressure condition, e.g., in a reducing atmosphere containing hydrogen (H₂), to present a higher relative density. In other words, formation of a reducing atmosphere (H₂) may allow the pellets a higher sintered density, and the sintering process may be performed at 1200° C. to 1400° C. for one to ten hours.

The metal bipolar plate prepared as described above eliminates the need for a high-cost coating process on the metal surface and allows for increased chemical stability, electric conductivity, mechanical strength, airtightness, reduced ionic conductivity, and a thermal expansion coefficient similar to that of an electrolyte, and is thus appropriate for use in solid oxide fuel cells (SOFCs) and solid oxide electrolysis cells (SOECs).

### First Embodiment: Preparation of LSM-Added Alloy Material of Metal Bipolar Plate

99.5 weight % of SUS430 and 0.5 weight % of LSM were weighed as per a stoichiometric ratio and were dried, crushed, and mixed for 30 minutes using an agate mortar. The resultant powder mixture was mixed with a solution obtained by mixing isopropyl alcohol (IPA) and toluene in a weight ratio of 65:35, added with 2 weight % of polyvinyl butyral (PVB), and then ball-milled and blended for 48 hours. The resultant slurry was dried at 100° C. in the air to obtain a powder, and the obtained powder was uniaxial press-formed into bar-shaped pallets. Thereafter, the pellets were further press-formed by cold isostatic pressing (CIP) into pellets having a higher density (e.g., green density). The cold isostatic pressed pellets were sintered at 1400° C. for ten hours. A powder of the material was scattered on the zirconia plate, and the pellets were placed thereon in order to prevent the pellets from reacting with the alumina tube surface of the sintering furnace during the sintering process. Further, the pellets were sintered in a hydrogen atmosphere to obtain a higher density while preventing oxidation, thereby preparing an alloy material for metal bipolar plate.

### Second Embodiment: Preparation of LSM-Added Alloy Material of Metal Bipolar Plate

The same process as that in the first embodiment except that 99 weight % of SUS430 and 1 weight % of LSM were used was conducted to prepare an alloy material for metal bipolar plate.

### Third Embodiment: Preparation of LSM-Added Alloy Material of Metal Bipolar Plate

The same process as that in the first embodiment except that 97 weight % of SUS430 and 3 weight % of LSM were used was conducted to prepare an alloy material for metal bipolar plate.

### Fourth Embodiment: Preparation of LSM-Added Alloy Material of Metal Bipolar Plate

The same process as that in the first embodiment except that 95 weight % of SUS430 and 5 weight % of LSM were used as conducted to prepare an alloy material for metal bipolar plate.

### Fifth Embodiment: Preparation of La₂O₃-Added Alloy Material of Metal Bipolar Plate

The same process as that in the first embodiment except that 99.5 weight % of SUS430 and 0.5 weight % of La₂O₃ were used was conducted to prepare an alloy material for metal bipolar plate.

### Sixth Embodiment: Preparation of La₂O₃-Added Alloy Material of Metal Bipolar Plate

The same process as that in the first embodiment except that 99 weight % of SUS430 and 1 weight % of La₂O₃ were used was conducted to prepare an alloy material for metal bipolar plate.

### Seventh Embodiment: Preparation of La₂O₃-Added Alloy Material of Metal Bipolar Plate

The same process as that in the first embodiment except that 97 weight % of SUS430 and 3 weight % of La₂O₃ were used was conducted to prepare an alloy material for metal bipolar plate.

### Eighth Embodiment: Preparation of La₂O₃-Added Alloy Material of Metal Bipolar Plate

The same process as that in the first embodiment except that 95 weight % of SUS430 and 5 weight % of La₂O₃ were used was conducted to prepare an alloy material for metal bipolar plate.

### Ninth Embodiment: Preparation of CeO₂-Added Alloy Material of Metal Bipolar Plate

The same process as that in the first embodiment except that 99.5 weight % of SUS430 and 0.5 weight % of CeO₂ were used was conducted to prepare an alloy material for metal bipolar plate.

### Tenth Embodiment: Preparation of CeO₂-Added Alloy Material of Metal Bipolar Plate

The same process as that in the first embodiment except that 99 weight % of SUS430 and 1 weight % of CeO₂ were used was conducted to prepare an alloy material for metal bipolar plate.

### Eleventh Embodiment: Preparation of CeO₂-Added Alloy Material of Metal Bipolar Plate

The same process as that in the first embodiment except that 97 weight % of SUS430 and 3 weight % of CeO₂ were used was conducted to prepare an alloy material for metal bipolar plate.

### Twelfth Embodiment: Preparation of CeO₂-Added Alloy Material of Metal Bipolar Plate

The same process as that in the first embodiment except that 95 weight % of SUS430 and 5 weight % of CeO₂ were used was conducted to prepare an alloy material for metal bipolar plate.

### Thirteenth Embodiment: Preparation of LaCrO₃-Added Alloy Material of Metal Bipolar Plate

The same process as that in the first embodiment except that 99.5 weight % of SUS430 and 0.5 weight % of LaCrO₃ were used was conducted to prepare an alloy material for metal bipolar plate.

### Fourteenth Embodiment: Preparation of LaCrO₃-Added Alloy Material of Metal Bipolar Plate

The same process as that in the first embodiment except that 99 weight % of SUS430 and 1 weight % of LaCrO₃ were used was conducted to prepare an alloy material for metal bipolar plate.

### Fifteenth Embodiment: Preparation of LaCrO₃-Added Alloy Material of Metal Bipolar Plate

The same process as that in the first embodiment except that 97 weight % of SUS430 and 3 weight % of LaCrO₃ were used was conducted to prepare an alloy material for metal bipolar plate.

### Sixteenth Embodiment: Preparation of LaCrO₃-Added Alloy Material of Metal Bipolar Plate

The same process as that in the first embodiment except that 95 weight % of SUS430 and 5 weight % of LaCrO₃ were used was conducted to prepare an alloy material for metal bipolar plate.

### COMPARISON EXAMPLE 1

### Preparation of Alloy Material of Metal Bipolar Plate Using SUS430 Alone

The same process as that in the first embodiment except that SUS430 alone was used without adding other element were used was conducted to prepare an alloy material for metal bipolar plate.

### EXPERIMENTAL EXAMPLE 1

### Analysis of Fine Structure

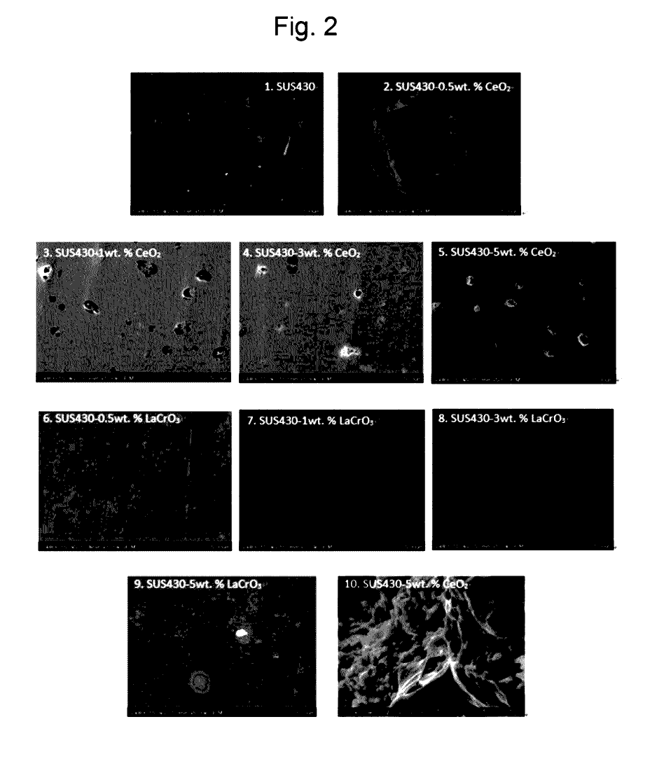

Scanning electron microscopy (SEM) images (e.g., pictures) (1 to 9) of a metal bipolar plate alloy material (SUS430) prepared according to comparison example 1, metal bipolar plate allow materials (SUS430-CeO₂) prepared according to the ninth to twelfth embodiment, and metal bipolar plate allow materials (SUS430-LaCrO₃) prepared according to the thirteenth to sixteenth embodiments and a fracture surface SEM image (e.g., picture) (10) of a metal bipolar plate alloy material prepared according to the twelfth embodiment are shown in FIG. 2. Referring to FIG. 2, it can be shown that CeO₂ is well dispersed in SUS430 in an independent phase.

### EXPERIMENTAL EXAMPLE 2

### EDS Component Analysis (EDS Mapping)

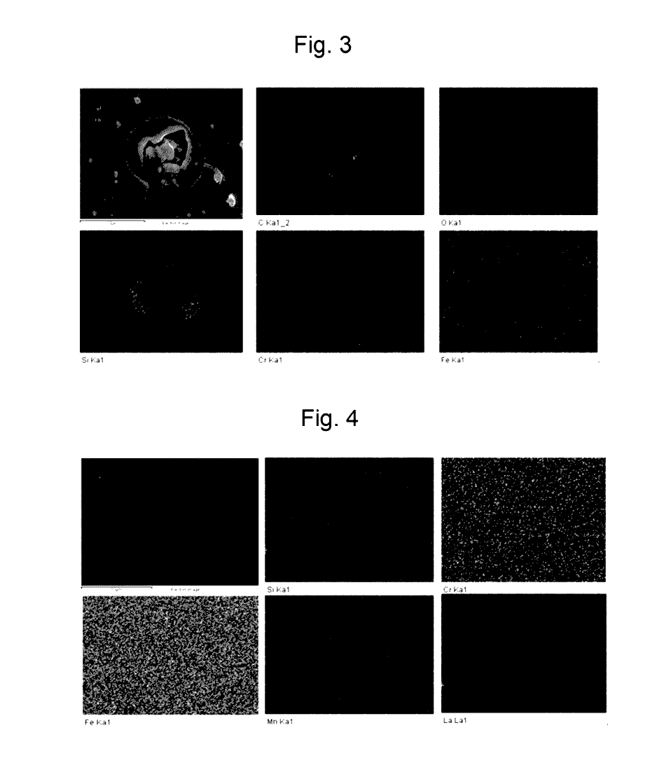

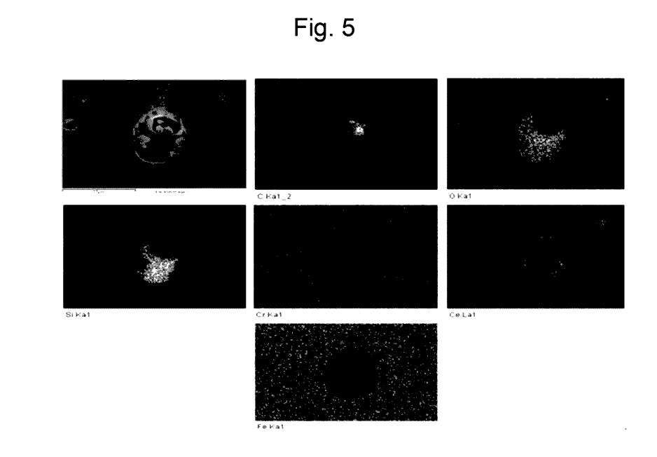

Results of energy dispersive spectroscopy (EDS) component analysis of a metal bipolar plate alloy material (SUS430) prepared according to comparison example 1, a metal bipolar plate alloy material (SUS430-CeO₂) prepared according to the twelfth embodiment, and a metal bipolar plate alloy material (SUS430-LaCrO₃) prepared according to the sixteenth embodiment are shown in images (e.g., pictures) in FIGS. 3 to 5. Referring to FIG. 3, it can be shown that iron (Fe) and chrome (Cr) which are main elements of SUS430 occupy a large area in EDS mapping, and silicon (Si) and manganese (Mn), which are trace elements in SUS430, are also dispersed. Referring to FIGS. 4 and 5, it can be shown that the added elements (CeO₂ and LaCrO₃) are evenly dispersed in SUS430, and in particular, the added elements are distributed at a higher density around air holes.

### EXPERIMENTAL EXAMPLE 3

### Measuring Sintered Density and Relative Density of Metal Bipolar Plate

The sintered density and relative density of the metal bipolar plate prepared according to the first to sixteenth embodiment were measured using, e.g., apparent (or bulk) density measurement, based on Equations 1 and 2, and their results are shown in Table 1 below.

Sintered density=weight/volume [Equation 1]

Relative density=sintered density/theoretical density×100 (%) [Equation 2]

TABLE 1

| | | | Relative |
|---|---|---|---|
| | Theoretical density | Sintered density | density |
| Composition | (g/cm³) | (g/cm³) | (%) |
| Comparison example 1 | 7.74 | 7.36 | 95.09 |
| First embodiment | 7.73 | 7.36 | 95.21 |
| Second embodiment | 7.73 | 7.36 | 95.21 |
| Third embodiment | 7.70 | 7.35 | 95.45 |
| Fourth embodiment | 7.68 | 6.99 | 90.98 |
| Fifth embodiment | 7.73 | 7.40 | 95.73 |
| Sixth embodiment | 7.73 | 7.36 | 95.21 |
| Seventh embodiment | 7.70 | 6.93 | 90.00 |
| Eighth embodiment | 7.68 | 6.70 | 87.25 |
| Ninth embodiment | 7.70 | 7.19 | 93.46 |
| Tenth embodiment | 7.70 | 7.35 | 95.58 |
| Eleventh embodiment | 7.68 | 7.17 | 93.29 |
| Twelfth embodiment | 7.67 | 7.32 | 95.36 |
| Thirteenth | 7.70 | 7.27 | 94.44 |
| embodiment | | | |
| Fourteenth | 7.69 | 7.37 | 95.77 |
| embodiment | | | |
| Fifteenth embodiment | 7.67 | 6.98 | 90.94 |
| Sixteenth | 7.65 | 7.17 | 93.70 |
| embodiment | | | |

Referring to Table 1 above, the metal bipolar plate alloy material prepared according to the first to sixteenth embodiment exhibits a higher relative density, and the relative density does not present a significant difference depending on the content of the added elements.

### EXPERIMENTAL EXAMPLE 4

### Theoretical Interpretation of Thermal Expansion Coefficient of Metal Bipolar Plate and Comparison and Analysis of Experimental Value

A theoretical thermal expansion coefficient (TEC) value of the metal bipolar plate (SUS430-CeO₂) prepared according to the twelfth embodiment computed based on Equation 3, which is Turner's equation, is in a range from about 10×10⁻⁶ m/m·K to about 13×10⁻⁶m/m·K, and the thermal expansion coefficient decreases as the CeO₂ content increases.

$$[ Equation 3 ]$$

$${α}_{r} = \frac{{α}_{SUS 430} {K}_{SUS 430} {F}_{SUS 430} / {ρ}_{SUS 430} + {α}_{oxide} {K}_{oxide} {F}_{oxide} / {ρ}_{oxide}}{{K}_{SUS 430} {F}_{SUS 430} / {ρ}_{SUS 430} + {K}_{oxide} {F}_{oxide} / {ρ}_{oxide}}$$

α=Thermal expansion coefficient

K=Bulk module=E/3(1-2 p)

E=Elastic module

μ=Possion's ratio

F=Weight fraction of phase

ρ=density

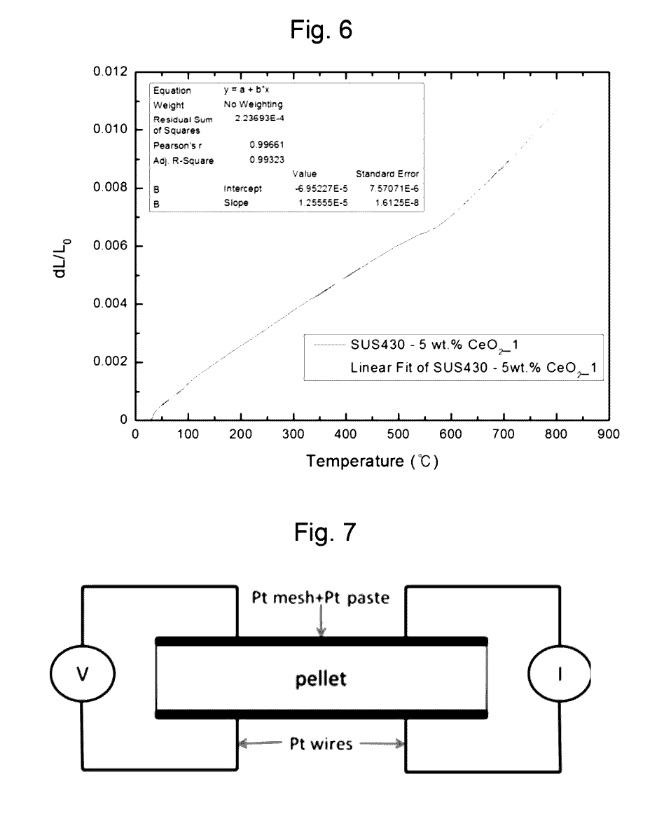

To compare the theoretical value with the experimental value, the thermal expansion ratio of the metal bipolar plate prepared according to the twelfth embodiment was measured in a temperature range front room temperature to 800° C. using a DIL 402C dilatometry apparatus of Netzsch which may measure a length change ratio as per temperature, and a result was shown in FIG. 6.

Referring to FIG. 6, it can be shown that the thermal expansion ratio of the metal bipolar plate prepared according to the twelfth embodiment is 12.56×10⁻⁶ m/m·K which is substantially identical to the theoretical value.

### EXPERIMENTAL EXAMPLE 5

### Measurement of Area Specific Resistance of Metal Bipolar Plate

As shown in FIG. 7, the area specific resistance of the metal bipolar plate prepared according to the first to sixteenth embodiment was measured. For example, the electrical resistance was measured by a four-terminal method, a sample of the metal bipolar plate was formed into a bar shape, two voltage measurement lines and two current measurement lines were stably attached to the bar-shaped metal bipolar plate, and the initial area specific resistance was measured in an oxidizing atmosphere at 800° C. The measured initial area specific resistance is shown in Table 2 below. A predetermined current was allowed to flow to the metal bipolar plate in an ohmic behavior range to measure voltage, and the resistance was computed based on the current and voltage. As the voltage and current measurement lines, platinum (Pt) lines were used to prevent an enhancement in contact resistance due to oxidation of the measurement lines, thereby ensuring reliability and reproductability of metal bipolar plate.

TABLE 2

| | ASR |
|---|---|
| Composition | (mΩ · cm²) |
| First embodiment | 7.04 |
| Second embodiment | 1.71 |
| Third embodiment | 5.64 |
| Fourth embodiment | 3.75 |
| Fifth embodiment (using micro La₂O₃) | 1.95 |
| Sixth embodiment (using micro La₂O₃) | 1.80 |
| Seventh embodiment (using micro La₂O₃) | 2.40 |
| Eighth embodiment (using micro La₂O₃) | 1.78 |
| Fifth embodiment (using nano La₂O₃) | 0.87 |
| Sixth embodiment (using nano La₂O₃) | 27.15 |
| Seventh embodiment (using nano La₂O₃) | 8.51 |
| Eighth embodiment (using nano La₂O₃) | 1.05 |
| Ninth embodiment | 3.73 |
| Tenth embodiment | 30.26 |
| Eleventh embodiment | 9.79 |
| Twelfth embodiment | 8.02 |
| Thirteenth embodiment | 17.65 |
| Fourteenth embodiment | 6.42 |
| Fifteenth embodiment | 14.78 |
| Sixteenth embodiment | 21.84 |

Referring to Table 2, it can be shown that the area specific resistance of the metal bipolar plate prepared according to the first to sixteenth embodiment presented a proper value, e.g., 1 mΩ·cm² to 30 mΩ·cm², and that as the content of added element increases, the area specific resistance tends to generally decrease.

### EXPERIMENTAL EXAMPLE 6

### Measurement of Increasing Speed of Area Specific Resistance of Metal Bipolar Plate

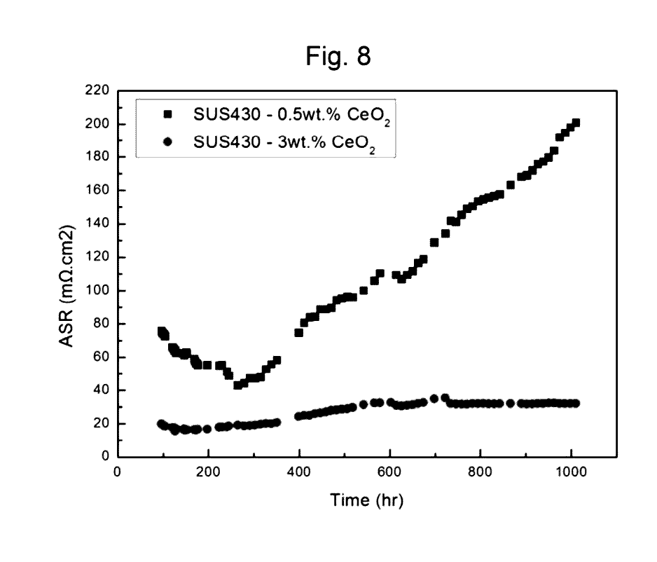

The increasing speed of area specific resistance was measured, using substantially the same four-terminal method as that in experimental example 5. Changes over time in the area specific resistance of the metal bipolar plate prepared according to the ninth to eleventh embodiment were measured, assessed, and shown in FIG. 8. The area specific resistance was assessed as value continuously measured up to one thousand hours.

Referring to FIG. 8, when the measurement was performed at 800° C. in an oxidizing atmosphere for one thousand hours, the metal bipolar plate (SUS430-0.5 wt % of CeO₂) prepared according to the ninth embodiment exhibited an area specific resistance increase of about 12.5 mΩ·cm², and the metal bipolar plate (SUS430-3 weight % of CeO₂) prepared according to the eleventh embodiment exhibited an area specific resistance increase of about 12.2 mΩ·cm². Thus, it can be shown that the metal bipolar plate maintains good durability even in long-term use.

### EXPERIMENTAL EXAMPLE 7

### Measurement of Heat Cycle of Metal Bipolar Plate

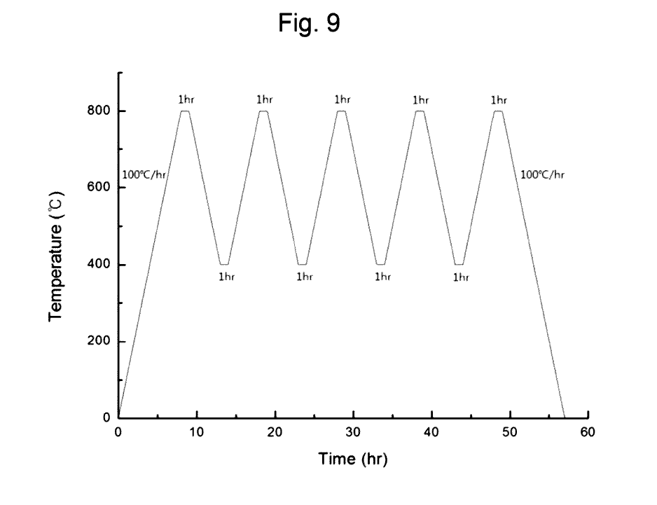

Heat cycle of the metal bipolar plate prepared according to comparison example 1 and the twelfth embodiment was measured using a four-terminal method. A metal bipolar plate sample was formed into a bar shape, two voltage measurement lines and two current measurement lines were stably attached to the bar-shaped metal bipolar plate sample that was then subjected to heat cycle between 800° C. and 400° C. in the air to measure the change in area specific resistance of the metal bipolar plate sample, and whether the change in area specific resistance is within a range in which the area specific resistance increasing speed varies. A buildup of oxide scale an the metal surface by heat cycle causes both a change in the area specific resistance of metal interface and change in the weight of the sample. In order to grasp the cause for the area specific resistance due to heat cycle and secure the reliability of the developed product, the change in weight of the sample and change in fine tissue both were inspected. Table 3 below shows values obtained by measuring, three times, the change in weight of the metal bipolar plate prepared according to the twelfth embodiment due to heat cycle three times after five heat cycles had been done. FIG. 9 is a graph illustrating the area specific resistance measured as per count of heat cycle on the metal bipolar plate sample presented according to the twelfth embodiment.

TABLE 3

Weight (g)

| Composition | Initial | After five cycles |
|---|---|---|
| Comparison example 1 (1) | 0.77 | 0.77 |
| Comparison example 1 (2) | 0.92 | 0.92 |
| Comparison example 1 (3) | 1.39 | 1.40 |
| Twelfth embodiment 12 (1) | 0.73 | 0.72 |
| Twelfth embodiment 12 (2) | 0.66 | 0.68 |
| Twelfth embodiment 12 (3) | 0.63 | 0.64 |

Referring to Table 3, it may be shown that after five heat cycles had been complete, the metal bipolar plate sample prepared according to the twelfth embodiment was slightly increased. Heat cycle test causes both a change in weight and change in the area specific resistance of metal interface due to the buildup of oxide scale on the metal surface as described above Referring to FIG. 9, it can be shown that as the count of heat cycle increases, the area specific resistance increases. After one heat cycle had been done, the area specific resistance was 3.10 mΩ·cm², and after five heat cycles, the area specific resistance was 5.88 mΩ·cm². In other words, it can be shown that the increment in area specific resistance between the five heat cycles is about 2.78 mΩ·cm² and thus anti-oxidation may be increased.

According to an embodiment of the present disclosure, there may be provided a metal bipolar plate and method for preparing the same, which eliminates the need for a high-cost coating process on the metal surface and allows for increased chemical stability, electric conductivity, mechanical strength, airtightness, reduced ionic conductivity, and a thermal expansion coefficient similar to that of an electrolyte, and is thus appropriate for use in fuel cells, such as solid oxide fuel cells (SOFCs) and solid oxide electrolysis cells (SOECs).

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A method for preparing a metal bipolar plate for a fuel cell, the method comprising:
drying, crushing, and mixing a Fe—Cr ferrite-based steel powder with a powder of an added element selected from the group consisting of LSM((La_{0.80}Sr_{0.20})_{0.95}MnO₃₋ₓ), La₂O₃, CeO₂, and LaCrO₃ to prepare a powder mixture;
mixing and ball-milling the powder mixture with a solvent and binder into slurry;
drying and press-forming the slurry into a pellet;
cold isostatic pressing the pellet; and
sintering the pellet.

2. The method of claim 1, wherein the Fe—Cr ferrite-based steel powder includes iron (Fe) and chrome (Cr) as main components.

3. The method of claim 2, wherein the Fe—Cr ferrite-based steel powder includes a Fe—Cr ferrite-based SUS430 powder.

4. The method of claim 1, wherein the Fe—Cr ferrite-based steel powder and the added element powder are mixed in a weight ratio of 90:10 to a weight ratio of 99.99:0.01.

5. The method of claim 1, wherein the slurry is prepared by mixing the powder mixture, the solvent, and the binder in a weight ratio of 1:1:0.01 to 0.03.

6. The method of claim 1, wherein the solvent includes isopropyl alcohol or a mix of isopropyl alcohol and toluene in a weight ratio of 65:35.

7. The method of claim 1, wherein the binder includes polyvinyl butyral.

8. The method of claim 1, wherein the slurry is dried at 90° C. to 100° C. in the air.

9. The method of claim 1, wherein the pellet is sintered at 1200° C. to 1400° C. in a hydrogen atmosphere for one hour to ten hours.

10. A metal bipolar plate for a fuel cell, the metal bipolar plate prepared by drying slurry including a Fe—Cr ferrite-based steel powder and a powder of an added element selected from the group consisting of LSM((La_{0.80}Sr_{0.20})_{0.95}MnO₃₋ₓ), La₂O₃, CeO₂, and LaCrO₃.

11. The metal bipolar plate of claim 10, wherein the slurry is prepared by mixing a powder mixture of the Fe—Cr ferrite-based steel powder and the added element powder, a solvent, and a binder in a weight ratio of 1:1:0.01 to 0.03.

12. The metal bipolar plate of claim 10, wherein the Fe—Cr ferrite-based steel powder includes a Fe—Cr ferrite-based SUS430 powder.

13. The metal bipolar plate of claim 10, wherein the Fe—Cr ferrite-based steel powder and the added element powder are mixed in a weight ratio of 90:10 to a weight ratio of 99.99:0.01.

14. A fuel cell including a metal bipolar plate prepared by drying slurry including a Fe—Cr ferrite-based steel powder and a powder of an added element selected from the group consisting of LSM((La_{0.80}Sr_{0.20})_{0.95}MnO₃₋ₓ), La₂O₃, CeO₂, and LaCrO₃.

15. The fuel cell of claim 14, wherein the fuel cell includes a solid oxide fuel cell (SOFC) or a solid oxide electrolysis cell (SOEC).
